(19) United States
(12) Patent Application Publication
(10) Pub. No.: US 2026/0166502 A1
(43) Pub. Date: Jun. 18, 2026

(54) SYSTEMS AND METHODS FOR PREPARING REDUCING LIQUIDS OF HIGH OXIDATION REDUCTION POTENTIAL

(71) Applicant: TRINE70 LLC, Boca Raton, FL (US)

(72) Inventors: Christopher ACCETTURO, Cooper City, FL (US); Eamonn FITZGERALD, Hollywood, FL (US); Jerry WHITLOCK, Boca Raton, FL (US)

(73) Assignee: TRINE70 LLC, Boca Raton, FL (US)

(21) Appl. No.: 18/847,495

(22) PCT Filed: Aug. 17, 2023
(86) PCT No.: PCT/US2023/072390

§ 371 Date: Sep. 16, 2024

Related U.S. Application Data
(63) Continuation-in-part of application No. PCT/US2023/062865, filed on Feb. 17, 2023.
(60) Provisional application No. 63/311,599, filed on Feb. 18, 2022.

(51) Int. Cl. B01F 35/21; B01D 61/02; C02F 1/32; C02F 1/44; C25B 1/04; C25B 9/19

(52) U.S. Cl. CPC B01F 35/2132; B01D 61/025; C02F 1/32; C02F 1/441; C25B 1/04; C25B 9/19

(57) ABSTRACT

The present disclosure relates to a system and a method system for preparing a reducing liquid in a continuous process. The system may comprise an electrolysis cell configured to generate an electrolytic reaction in order to produce a reducing gas, a conduit configured for receiving a source liquid from a source, the conduit further comprising a gas introduction element for introducing the reducing gas to a first liquid in order to produce the reducing liquid, and a mixing element for receiving the reducing liquid. The system may also comprise a dosing pump for infusing the reducing liquid with a metal salt such as a metasilicate. The resultant reducing liquid from the exemplary processes are found to have ORP values of about −100 mV or more negative, and a stable pH of 9.5 or greater, stable over a period of at least 24 months.

### FIELD OF THE INVENTION

The present invention relates to systems and continuous processes for producing reducing liquids.

### BACKGROUND

The term “reduced water” is used to describe liquid water which has been ionized, adding to the solution “free” electrons, converting it into a reducing agent. These electrons affect the water's ability to function as a reducing agent, that is, it loses electrons to other substances around it. The antagonist to a reducing agent is an oxidizing agent, which strips electrons from the surrounding energy system.

Reducing Liquids have many applications, such as water purification, preparing Ready to Drink (RTD) beverages, medical device preparation, dietary supplement preparation, inhalation, wound treatment, industrial wastewater or effluent treatment, and municipality sewage treatment.

In the field of health, oxidative stress is a condition where free radicals have taken electrons out of the body system, resulting in an imbalance between the production of free radicals and antioxidants. Reduced water has been shown as an effective antioxidant and is used in the treatment or management of many adverse health conditions.

In industry, reducing agents are used to purify or decontaminate water, clean or degrease components prior to use in another process, ensure environmental standards are met in mining or sewage treatment processes, as well as being used in place of harsh detergents which may be harmful to humans, livestock, or environmental processes.

Methods for producing reduced water have existed for some time now. One method for achieving the desired levels of ionization is infusing hydrogen gas produced by an electrolysis cell. US20040118775A1 details a process for producing reduced water using the hydrogen gas method. Current systems and methods for large scale production of high oxidation reduction potential (ORP) liquids, specifically ready to drink beverages, which have a highly negative ORP value and have a stable alkaline pH value of 9.5 or greater, are dimensionally cumbersome, time consuming, and comparatively expensive when employing current art embodiments.

Another issue with currently utilized processes is overexposure of the target solution to the production process (specifically turbulence and cavitation) based on antiquated procedures, resulting in less-than-ideal product which may be less stable over time, have a less effective oxidation reduction potential value, require significant amounts of time to produce, or require larger amounts of salt or mineral additives; and in turn bear a higher standard cost of production. US20210214248A1 discloses a process for producing high ORP, alkaline solutions through a batching method requiring 55 minutes to 65 minutes minimum where the in-process water is recirculating within the pump circuit, and 10 hours to produce up to 5000 gallons. Therefore, the recirculating batch method detailed in US20210214248A1 is not suitable for commercial use.

Extensive testing has been performed by the inventors and has shown the batching process to have a degrading effect on the overall quality of the finished product. Degradation can present as ORP value moving positive over time during process, in the batching process, pH value moving toward 7 after bottling at a faster rate than is desirable, and ORP value moving more positive at a faster rate in bottle than is desirable.

It is therefore desirable to provide systems and methods that enable the large-scale production of these reducing liquids in a highly stable state, which requires significantly less time to process, requires a smaller dose of added salts or minerals, and a reduction in required processing equipment.

### SUMMARY

According to a first aspect of the present disclosure, there is provided a method for preparing a reducing liquid in a continuous process, comprising the following steps:
providing a first liquid in a reaction volume of an electrolysis cell;
generating an electrolytic reaction in the reaction volume in order to produce a reducing gas comprising one or more of oxygen and hydrogen;
providing a source liquid in a second volume;
introducing the reducing gas to the source liquid using a gas introduction element, thereby producing the reducing liquid; and
directing the reducing liquid through a mixing element.

Optionally, the method further comprises adding a mineral salt to the reducing liquid. Optionally the mineral salt comprises a metasilicate. The introduction of a metal salt, such as a metasilicate, to the source liquid or to the gas-saturated source liquid, can reduce the ORP value and contribute to regulating a pH value.

Optionally, the metasilicate is added to the gas-saturated source liquid in an amount in a range of from about 0.5 cc per gallon to about 5 cc per gallon.

Optionally, the metasilicate is added to the gas-saturated source liquid using a dosing pump or a Venturi.

Optionally, the gas introduction element comprises a Venturi.

Optionally, the mixing element comprises a static mixing element. The inventors have found that excessive, active mixing can create overexposure which may result in flocculation of constituents and/or rapid degradation of the ORP value of the reducing liquid, whilst underexposure to the mixing process may result in stratification of constituents. The use of a static mixing element provides the benefits of mixing whilst mitigating the issues associated with overexposure. In various embodiments the mixing element optionally comprises helical portions, square portions, rectangular portions, circular portions, and/or grid(s).

Optionally, the method further comprises the step of providing the source liquid using one or more pumps, a siphon, gravity, or an air pressure differential.

Optionally, the source liquid comprises reverse osmosis filtered water, wherein the optionally the source liquid is disinfected using one or more of ozone, ultraviolet light, and a steam distillation process.

Optionally, the source liquid comprises wastewater, effluent, or water from an industrial process.

Optionally, the electrolysis cell comprises an alkaline water electrolysis cell, and the method further comprises the steps of: providing an electrolyte in the form of a liquid or a solid to the electrolysis cell, and adding water to the electrolyte in order to produce a water-based alkaline electrolyte mixture for the electrolytic reaction.

Optionally, the electrolyte provided to the electrolysis cell comprises water, potassium hydroxide, and/or sodium hydroxide.

Optionally, the electrolyte is provided at a density in the range of about 26% and about 28% by weight in solution.

Optionally, the electrolyte is provided at a density of about 30% by weight in solution.

Optionally, the oxidation reduction potential (ORP) value of the reducing liquid after saturation is about −100 mV or more negative.

Optionally, the second volume comprises a conduit characterised by the following dimensions:

$${L}_{S} = 10 ( D ) , and$$

$${L}_{P} = 30 ( D ) ;$$

wherein D is the inside diameter of the conduit, L_{S} is the minimum length of gas saturation, and L_{P} is the minimum total length of the conduit measured from the gas introduction element to the outflow of the conduit.

Optionally, the conduit is further characterized by the following dimensions:

$${L}_{I} = 4 ( D ) ,$$

wherein L₁ is the minimum length of mineral salt infusion prior to mixing.

Optionally, the method further comprises the step of reducing, or increasing, the pressure of the reducing liquid after directing the reducing liquid through the mixing element.

According to a second aspect of the present disclosure, there is provided a system for preparing a reducing liquid in a continuous process, comprising:
an electrolysis cell configured to generate an electrolytic reaction in order to produce a reducing gas; and
a conduit configured for receiving a source liquid from a source, the conduit further comprising:
a gas introduction element for introducing the reducing gas to a first liquid in order to produce the reducing liquid; and
a mixing element for receiving the reducing liquid.

Optionally, the conduit further comprises a dosing pump for infusing a mineral salt in to the reducing liquid, wherein optionally the mineral salt comprises a metasilicate.

Optionally, the system further comprises a flow meter communicatively coupled to the dosing pump.

Preferably, the dimensions of the conduit are characterised by:

$${L}_{S} = 10 ( D ) , and$$

$${L}_{P} = 30 ( D ) ;$$

wherein D is the inside diameter of the conduit, L_{S} is the minimum length of gas saturation, L₁ is the minimum length of metasilicate infusion prior to mixing, L_{P} is the minimum total length of the conduit measured from the gas introduction element to the outflow of the conduit.

Optionally, the conduit is further characterized by the following dimensions:

$${L}_{I} = 4 ( D ) ,$$

wherein L₁ is the minimum length of mineral salt infusion prior to mixing.

Preferably, the mixing element is a static mixing element.

Optionally, the electrolysis cell comprises an alkaline water electrolysis cell or a Proton Exchange Membrane (PEM) type generator.

Optionally, the electrolyte provided to the electrolysis cell comprises water, potassium hydroxide, and/or sodium hydroxide.

Optionally, the electrolyte is provided at a density in the range of about 26% and about 28% by weight in solution, or at a density of about 30% by weight in solution.

Optionally, the electrolyte is provided as a liquid or as a solid.

Optionally, the electrolysis cell is configured to generate a voltage in the range of about 2V and about 220V.

Optionally, the system is configured to maintain the reducing gas at a pressure in the range of about 5 psi and about 10 psi in the gas introduction element.

Optionally, the source of the source liquid is an industrial process, effluent, wastewater, or reverse osmosis filtered water. Using the exemplary systems and processes of the present disclosure, liquids that would otherwise find few uses due to their quality can be treated and recycled for consumption or other applications.

According to a third aspect of the present disclosure, there is provided a method for preparing a liquid with high oxidation-reduction potential (ORP), comprising the following steps:
providing a reducing liquid;
infusing a metasilicate in to the reducing liquid; and
directing the metasilicate infused reducing liquid through a mixing element.

According to a further aspect of the present disclosure, there is provided a method for preparing a reducing liquid in a continuous process, comprising the following steps:
providing a source liquid in a volume;
adding a mineral salt to the reducing liquid, wherein optionally the mineral salt comprises a metasilicate thereby producing the reducing liquid; and
directing the reducing liquid through a mixing element.

According to a further aspect of the present disclosure, there is provided a apparatus for producing a reducing liquid according to the exemplary methods of the present disclosure, comprising a conduit characterised by the following dimensions:

$${L}_{S} = 10 ( D ) , and$$

$${L}_{P} = 30 ( D ) ;$$

wherein D is the inside diameter of the conduit, L_{S} is the minimum length of gas saturation prior, and L_{P} is the minimum total length of the conduit measured from the gas introduction element to the outflow of the conduit.

Preferably, when the process further comprises a step of adding a mineral salt to the reducing liquid, the conduit is further characterized by the following dimensions:

$${L}_{I} = 4 ( D ) ,$$

wherein L₁ is the minimum length of mineral salt infusion prior to mixing.

According to a further aspect of the present disclosure, there is provided a product prepared at least in part using the exemplary methods described herein. The product may comprise an alcoholic or a non-alcoholic product, a carbonated beverage, a fruit juice product, ready-to-drink water, a tea product, or a coffee product. Alternatively the product may comprise a medicament.

According to a further aspect of the present disclosure, there is provided a continuous process for preparing RTD water of high ORP and alkaline pH 9.5+ with a nominal flow rate of about 80 gpm, comprising the following steps:
a. Providing purified reverse osmosis filtered water to process at a nominal rate of 80 gpm.
b. Providing an alkaline electrolyte solution, wherein the alkaline electrolyte comprises water, potassium hydroxide and/or sodium hydroxide at a nominal density of 30% by weight in solution;
c. Optionally, the alkaline electrolyte solution may be presented as a liquid, or solid;
d. Introducing the alkaline electrolyte into a custom designed, or commercially available electrolysis cell, wherein the cell is configured to produce an electrolytic reaction yielding hydrogen gas, oxygen gas, or a combination thereof, in any combined range, mixes of gasses, from any other source;
e. Adding water to the reaction volume of the electrolysis cell to provide a water based-alkaline electrolyte mixture;
f. Applying a direct current in the water based-alkaline electrolyte mixture to produce the reducing gas, wherein the voltage is based on specific cell design parameters. The voltage will preferably range between about 2.2V direct current and about 220V direct current;
g. Introducing the reducing gas into a gas introduction element, wherein the gas is preferably maintained at 5 psi and lower (never exceeding 10 psi);
h. Adding reverse osmosis filtered water to the gas introduction element through a continuous flow method at a nominal rate of 80 gpm, such that the reverse osmosis filtered water absorbs the reducing gas;
i. Allowing the reducing liquid from the gas introduction element to continue through the continuous flow process;
j. Metering a metasilicate into the reducing liquid, whereby the reducing liquid alkaline pH is maintained at 9.5+. The prescribed dose will vary based on specific metasilicate recipes ranging from 0.5 cc per gallon up to 5 cc per gallon;
k. Allowing the processed liquid to pass through a single motionless mixer element optimized to fully mix the solution while preventing:
   i) underexposure to the mixing process which may result in stratification of constituents or;
   ii) overexposure to the mixing process which may result in flocculation of constituents and or rapid degradation of ORP value.

Optionally, the reverse osmosis water is disinfected using ozone, UV light, and/or steam distillation.

Optionally, the process further comprises the step of providing, in the gas introduction element, oxygen gas and hydrogen gas.

According to a further aspect of the present disclosure, there is provided a process for producing a reducing liquid for use in preparation of ready-to-drink (RTD) water, comprising the following steps:
a. providing, in a gas introduction element from an electrolysis cell: oxygen gas from 0% to 100% by volume, and/or hydrogen gas from 0% to 100% by volume and;
b. Adding a liquid metasilicate by dosing pump injection, Venturi introduction, or any suitable introduction method to the injection port;
c. Adding reverse osmosis filtered water through a gas introduction element at a nominal rate, wherein the reverse osmosis filtered water absorbs the gas from the electrolysis cell to produce a reducing liquid with an oxidation reduction potential (ORP) value of about −100 mV or more negative
d. The liquid provided to the gas introduction element may have a neutral or positive ORP value, and the gasses are absorbed by the reverse osmosis water within the Venturi type introducer.
e. Directing the reducing liquid through a single motionless mixer element;
f. Advantageously, it is found that the ORP of the resultant reducing liquid post-mixing may be more negative.

According to a further aspect of the present disclosure, there is provided a process for producing a reducing liquid for use in preparation of ready-to-drink (RTD) water, comprising the following steps:
a. providing, in a Venturi type introducer: hydrogen gas produced by water electrolysis or other method and;
b. a liquid metasilicate may be added by dosing pump injection, Venturi introduction, or any suitable introduction method;
c. Adding reverse osmosis filtered water having a neutral or positive ORP value through a gas introduction element, wherein the reverse osmosis filtered water absorbs the gas to produce a reducing liquid with an oxidation reduction potential (ORP) value of about −100 mV or more negative. The gasses are absorbed by the reverse osmosis water within the gas introduction element.
d. Directing the reducing liquid passes through a single motionless mixer element;
e. Advantageously, the ORP of the resultant reducing liquid post mixing may be more negative.

According to a further aspect of the present disclosure, there is provided a process for producing a reducing liquid for use in preparation of ready-to-drink (RTD) water, comprising the following steps:
a. providing, by dosing pump injection, Venturi introduction, or any suitable introduction method, a liquid metasilicate;
b. Adding reverse osmosis filtered water through introduction element, wherein the reverse osmosis filtered water absorbs the metasilicate to produce a reducing liquid with an oxidation reduction potential (ORP) value of about −100 mV or more negative. The liquid provided to the introduction element may have a neutral or positive ORP value. The liquid metasilicate is absorbed by the RO filtered water in the introduction element.
c. Directing the reducing liquid through a single motionless mixer element; and
d. Advantageously, the ORP of the resultant reducing liquid post mixing may be more negative.

According to a further aspect of the present disclosure, there is provided a process for producing a general reducing liquid comprising the following steps:
a. providing, in a Venturi type introducer: a reducing gas mixture comprising of hydrogen gas between 100% and 0% by volume, and oxygen gas between 100% and 0% by volume,
b. Adding a liquid of neutral or positive ORP value through a Venturi type introducer in order to reduce the liquid. In embodiments, the liquid may contain environmental pollutants intended to be reduced, and/or industrial byproducts intended to be reduced. Alternatively the liquid may comprise reverse osmosis filtered water. The liquid metasilicate is absorbed by the liquid in the introduction element.
c. The liquid absorbs the gas to produce a reducing liquid with an oxidation reduction potential (ORP) value of about −100 mV or more negative;
d. Optionally adding a liquid metasilicate to further reduce the reducing liquid's ORP value;
e. Directing the reducing liquid through a single motionless mixer element;
f. Advantageously, the ORP of the resultant reducing liquid post-mixing may be more negative.

According to a further aspect of the present disclosure, there is provided a process for producing a general reducing liquid comprising the following steps:
a. providing, in a Venturi type introducer: hydrogen gas;
b. Adding a liquid with a neutral or positive ORP value through a Venturi type introducer which is intended to be reduced. In embodiments, the liquid may contain environmental pollutants intended to be reduced, and/or industrial byproducts intended to be reduced. Alternatively the liquid may comprise reverse osmosis filtered water.
c. wherein the liquid absorbs the gas to produce a reducing liquid with an oxidation reduction potential (ORP) value of about −100 mV or more negative;
d. Directing the reducing liquid passes through a single motionless mixer element.
e. Advantageously, the ORP of the resultant reducing liquid post mixing may be more negative.

According to a further aspect of the present disclosure, there is provided a process for producing a general reducing liquid comprising the following steps:
a. providing, in a Venturi type introducer: oxygen gas;
b. Adding a liquid with a neutral or positive ORP value through a Venturi type introducer which is intended to be reduced. In embodiments, the liquid may contain environmental pollutants intended to be reduced, and/or industrial byproducts intended to be reduced. Alternatively the liquid may comprise reverse osmosis filtered water.
c. wherein the liquid absorbs the gas to produce a reducing liquid with an oxidation reduction potential (ORP) value of about −100 mV or more negative;
d, wherein the reducing liquid passes through a single motionless mixer element;
e. Advantageously, the ORP of the resultant reducing liquid post mixing may be more negative.

According to a further aspect of the present disclosure, there is provided a process for producing a general reducing liquid comprising the following steps:
a. providing, by dosing pump injection, Venturi introduction, or any suitable introduction method: a liquid metasilicate;
b. Adding a liquid with a neutral or positive ORP value through an introduction element which is intended to be reduced. In embodiments, the liquid may contain environmental pollutants intended to be reduced, and/or industrial byproducts intended to be reduced. Alternatively the liquid may comprise reverse osmosis filtered water. The introduction element may comprise an injection port operably connected to the dosing pump.
c. wherein the liquid absorbs the metasilicate to produce a reducing liquid with an oxidation reduction potential (ORP) value of about −100 mV or more negative
d. Directing the reducing liquid passes through a single motionless mixer element;
e. Advantageously, the ORP of the resultant reducing liquid post mixing may be more negative.

### BRIEF DESCRIPTION OF THE DRAWINGS

The illustrative embodiments of the present disclosure are described with reference to the appended drawing. The illustrated embodiment is intended to illustrate, but not to limit, the disclosure.

FIG. 1 provides a schematic diagram illustrating components of a system for producing a reducing liquid, according to embodiments of the present disclosure;

FIG. 2 provides a schematic diagram illustrating components of a system for producing a reducing liquid, according to embodiments of the present disclosure;

FIG. 3 provides a plan view of a system for producing a reducing liquid according to a continuous flow process, particularly illustrating relative lengths of different stages of a continuous flow process according to embodiments of the present disclosure, although not necessarily to scale;

FIG. 4 provides a chart of experimental data illustrating how much reducing liquid can be produced using continuous flow process embodiments of the present disclosure compared with the batching process described in U.S. Publication No. US20210214248A1;

FIG. 5 provides a schematic diagram illustrating components of a system for producing a reducing liquid, according to embodiments of the present disclosure;

FIG. 6 provides a flow diagram illustrating a continuous flow process for preparing a reducing liquid according to an embodiment of the present disclosure;

FIG. 7 provides a flow diagram illustrating a continuous flow process for preparing a reducing liquid according to an embodiment of the present disclosure; and

FIG. 8 provides detail on the absorption of bubbles in solution after gas introduction, prior to static mixing.

### DETAILED DESCRIPTION OF THE DRAWINGS

The present disclosure is intended as a description of various configurations of the subject technology and is not intended to represent the only configurations in which the subject technology may be practiced.

The term “about” as used herein indicates the value of a given quantity varies by ±10% of the value, or optionally ±5% of the value, or in some embodiments, by ±1% of the value so described. For example, “about −100 mV” encompasses a range of values from −90 mV to −110 mV, inclusive.

Through continuous process development and refinement, the inventors have determined a major impediment to current production methods for producing these high oxidation reduction potential liquids which have a stable alkaline pH value of 9.5 or greater, as well as liquids which may be dosed with metasilicates or other mineral bonded salts, is a batching process requiring recirculation of target liquid for extended periods of time while waiting for the solution to reach a target ORP. The inventors have found that continuously subjecting the product to repeated turbulence and cavitation while recirculating through pumps, motionless mixers, aeration from height, and other factors, negatively impact the quality of the final product water. Excessive treatment of the liquid may destabilize the ORP value, cause flocculation and/or stratification of the additives, as well as causing an observed adverse drop and or variation in final pH value of the packaged product.

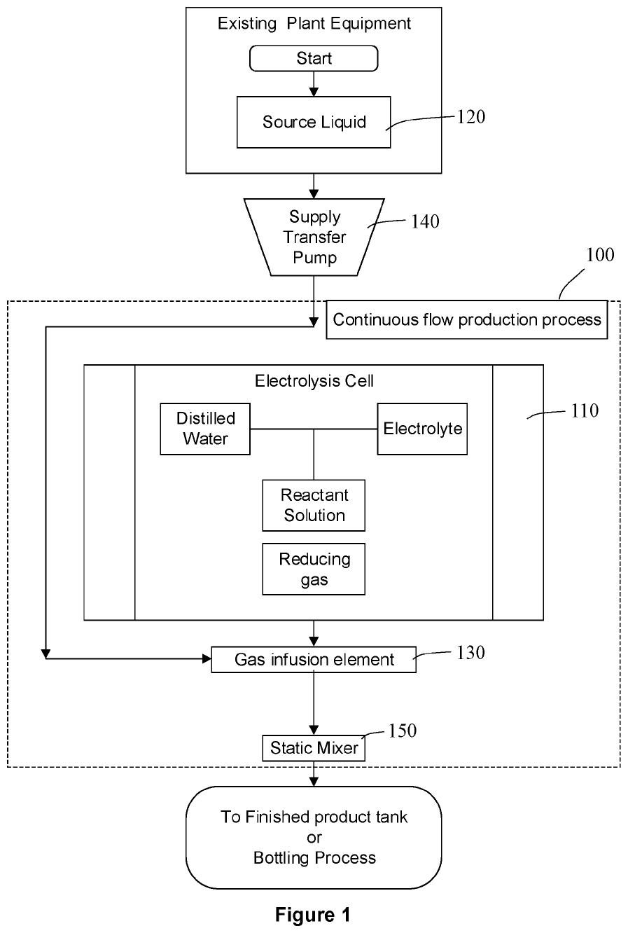

FIG. 1 provides a schematic view of a system 100 for producing a reducing liquid in a continuous process according to embodiments of the present disclosure. The system 100 includes an electrolysis cell 110 for producing a reducing gas that will be introduced in to a source liquid 120 by way of a gas introduction element 130. The source liquid 140 can be provided to the gas introduction element 130 using, for example, a supply transfer pump 140. The reducing liquid produced by saturation of the source liquid with the gas from electrolysis cell 110 is then directed to a static mixing element 150. Following mixing at the static mixing element 150, the reducing liquid may be bottled or otherwise stored in container(s), or may be utilized in another industrial process.

The electrolysis cell 110 may comprise, but is not limited to, a commercially available bipolar, alkaline, water electrolytic cell. Examples of these alkaline electrolyzers are explained in US20040040838A1 and U.S. Pat. No. 4,111,779A. Another embodiment may utilize Proton Exchange Membrane (PEM) type electrolytic cells that do not require an electrolyte to be added to the cell, but rather rely on pure water for their proper operation and gas production mechanism. Custom designed electrolytic cells may be used in place of commercially available units.

Whilst an electrolysis cell can be included in the system 100, it will be appreciated that a pre-prepared source of reducing gas may be utilized in addition or alternatively.

At least a first liquid is provided to electrolysis cell 110 for the electrolytic reaction. In various embodiments, the first liquid may comprise water including distilled water, reverse osmosis treated water, ozone treated water, and UV-light treated water. A purified source water for RTD applications is generally produced by the Reverse Osmosis process (RO). RO water is produced using high pressure to force water through a semipermeable membrane, removing nearly all impurities from the water by overcoming the osmotic pressure of the solution. Osmotic pressure is a solution's chemical affinity to evenly distribute solutes within a solution. RO water is characterized as having a conductivity between that of deionized water and drinking water. RO water conductivity can range from about 1 μS/cm to about 20 μS/cm. The processes of the present disclosure ideally use as a source liquid water with a conductivity between about 5 μS/cm and about 15 μS/cm, and more preferably about 7 μS/cm and about 12 μS/cm.

Ideally lower conductivity values yield a more controlled final product, however lowering the conductivity value of the source water requires increasingly complex and expensive equipment. A drawback to the production process is in an effort to decrease the conductivity of the water, more water needs to be wasted as part of the process. To achieve low single digit conductivity values, more wastewater will be produced than product water.

For bipolar, alkaline, water electrolytic cells an electrolyte is also used, to increase conductivity and allow gas to be produced. The electrolyte may be provided as a liquid or as a solid, and the constituents of this electrolyte mixture may consist of water, potassium hydroxide (KOH), sodium hydroxide (NaOH), or other electrolyte mixtures based on the manufacturer's recommendations. The ideal concentration of electrolyte will be determined by the design specifications of the electrolytic cell; however, most cells will follow a general convention of 30% by weight solid electrolyte in solution (Guillet and Millet, Hydrogen Production: by Electrolysis, First Edition 2015). It should be noted that the electrolyte solution does not transpose to the produced gas, but only serves to increase conductivity within the cell to produce the gas using electricity.

The operating pressure of the gas generation system can operate in both low vacuum, as well as low pressure conditions. In various embodiments, minimum and maximum pressure conditions for this specific embodiment range from about −1.5 psi to about 5.5 psi. Ideally the system operates between about −0.5 psi and about 0.5 psi. Pressure can be controlled by reducing or increasing the voltage applied to the cell, increasing or decreasing the vacuum applied by the gas introduction element of the overall system, as well as incorporating a venting pressure regulator if necessary.

The amount of gas required for this process is dependent on the customer requirement for minimum ORP value. In one embodiment, the system is configured to accept a flow rate of process liquid between about 30 gallons per minute and about 100 gallons per minute, while infusing reducing gas within a range of about 15 CFM to about 31 CFM. This specific system will yield reduced water with a final ORP of about −100 mV to about −500 mV. Different embodiments of the invention can produce ORP ranges from about 0 mV to −100 mv, about −100 mV to about −300 mV, about −250 mV to about −500 mV, and about −100 mv to about −800 mV depending on configuration based on product and customer needs.

A source liquid 120 is provided to a gas introduction element 130, for example by way of supply transfer pump 140. The gas introduction element 130 can be any in-line device to add the reducing gas produced in the electrolysis cell 110. In one embodiment, the gas introduction element 120 element comprises a Mazzei injector system such as the one detailed in US20090314702A1, or any commercially available Venturi introducer. The Venturi system is sized based on the piping diameter and flow rate of the system being interfaced. Using flow rate and pressure, the amount of vacuum the system will create can be fine-tuned, injecting the correct amount of reducing gas necessary to treat the product water and achieve the desired ORP value. These flow-driven devices are widely used in industry and are readily available off the shelf. If desired, this Venturi introducer may be custom designed to application at the designer's discretion.

In various embodiments, the source liquid 120 is supplied by one or more of pumps, siphon, gravity, air pressure, or any other supply method external to the Continuous Flow Process system 100.

The Venturi introducer is advantageous over a standard “T” or “Y” connection not only because it will draw the gas into solution, but also because it atomizes the gas into much smaller bubbles in comparison to a port that lacks a Venturi-type mechanism of action. For example, the Venturi may be configured to produce millimeter or sub-millimeter-sized bubbles, whereas the standard “T” or “Y” connection only produce bubbles of centimeter-sized or larger. If the system was to be connected without the Venturi or similar gas injection element, it may require the gas to be supplied to the system at pressures much higher than the ideal design requirements for the gas production cell, as the gas would need to overcome the pressure within the fluid path.

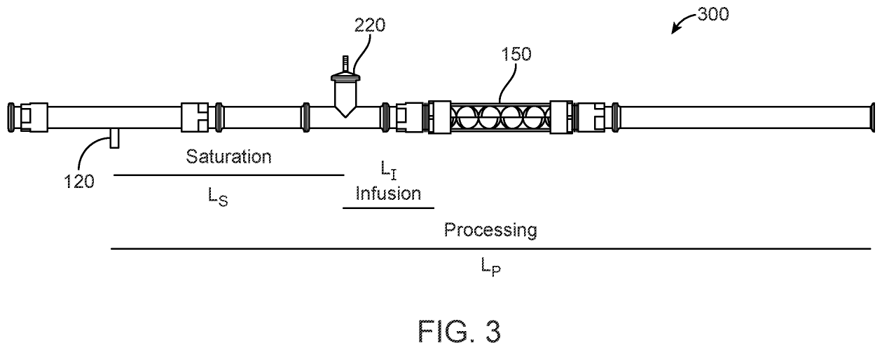

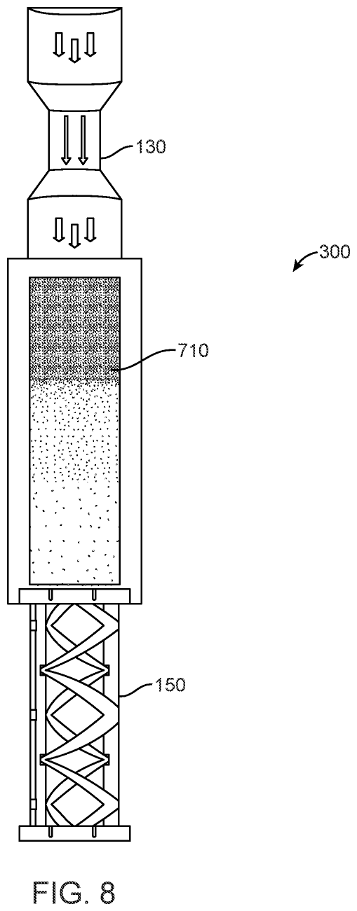

FIG. 8 provides a pictorial representation of the uptake of the bubbles 710 of the reducing gas, provided either by a reaction in the electrolysis cell 110 or by other means, in to the source liquid. Part of the conduit 300 of FIG. 3 is shown, as well as gas introduction element 130 and static mixing element 150.

The reducing liquid produced at the gas introduction element 130 is then directed towards a static mixing element 150, which may be a standard off the shelf motionless mixer such as, but not limited to, the mixer detailed in U.S. Pat. No. 3,923,288. The purpose of using a motionless mixer 150 is to reduce the overall cavitation and turbulence exerted on the product water when compared to product water being continuously recirculated through a centrifugal pump or any method of recirculation, which would negatively impact the process over time. Motionless mixers are sized by the viscosity of the product being treated, as well as flow rate, and pipe diameter as detailed by their manufacturer. In various embodiments, a mixing element 150 that achieves the same purpose but is custom designed and used in place of the off the shelf version may be used dependent on customer or design needs.

Once the reducing liquid has passed through the motionless mixer, the solution is immediately available in continuous flow, for final packaging or use in conjunction with another industrial process. The solution is found to have numerous possible uses, including but not limited to use for water purification, preparing RTD beverages, medical device preparation, dietary supplement preparation, inhalation, wound treatment, industrial wastewater or effluent treatment, and municipality sewage treatment.

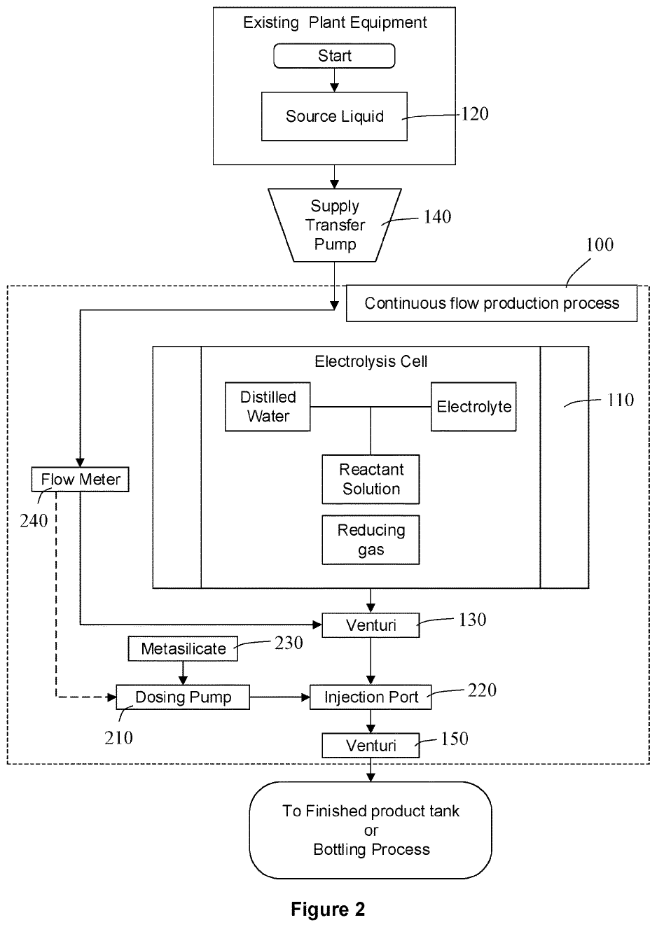

FIG. 2 provides a schematic diagram of the system 100 of FIG. 1 for producing a reducing liquid in a continuous flow process, but including additional elements which will now be discussed. In particular, FIG. 2 illustrates the inclusion of dosing pump 210 and injection port 220 for infusing a mineral salt, preferably a metasilicate 230, in to the reducing liquid in order to further reduce the ORP value of the reducing liquid. In one embodiment, the dosing pump 210 is configured to provide the metasilicate to the reducing liquid in an amount in a range of from about 0.5 cc per gallon to about 5 cc per gallon. In various embodiments, the injection port 220 may comprise a Venturi, a Y connection, or a T connection. The inclusion of dosing pump 210 and injection portion 220 facilitates controlled distribution of the metasilicate 230 prior to the static mixing element 150. However, in an instance where the high reduction potential liquid is being produced solely with the reducing gas such as in the embodiment of FIG. 1, the injection port and dosing pump can be omitted from the system 100.

Preferably, the step of infusing with a metasilicate may utilize a compound generally referred to as sodium silicate. This compound is a metasilicate comprising multiple forms of hydrated silicates, primarily Trimeric Sodium Silicate and Sodium Silicate Pentahydrate. However the scope of this disclosure is not limited to this specific formulation, and other mineral salts are envisaged by the inventors as being within the scope of the present disclosure.

Using commercially available dosing equipment, the amount of metasilicate can be fine-tuned to meet the customer's recipe requirement for end-product composition. The dosing pump 210 can be configured to meet product specification for end-product pH, or quantity of metasilicate per quantity of water being treated. These dosing systems may be of the single diaphragm, dual diaphragm, or peristaltic configurations. One example of a dual diaphragm pump is described in US20210047209A1. If dosing by volume, the dosing pump 210 may be interfaced with an in-line flowmeter 240, indicated by a dashed line in FIG. 2 leading to dosing pump 210, to calculate the required volume to be added in real time. In another embodiment, an in-line pH meter (not pictured) that interfaces with the doing pump 210 may be added to adjust the slope of the dosing prescription.

FIG. 3 provides an illustrative example of the relative treatment distances for the continuous flow process of the present disclosure, although not necessarily to scale. Conduit 300 is operably connected, either integrally or detachably, to a source (not pictured) of the source liquid, as well as the gas introduction element 120, and the injection port 220. For optimum gas infusion and ionization levels within solution, the required length of the system 100 piping can be given by the following equations:

$${L}_{S} = 10 ( D ) , \qquad ( 1 )$$

$${L}_{I} = 4 ( D ) , and \qquad ( 2 )$$

$${L}_{S} = 30 ( D ) ; \qquad ( 3 )$$

where:
L_{S}=Minimum length of gas saturation prior to metasilicate infusion;
L₁=Minimum length of metasilicate infusion prior to mixing;
L_{P}=Minimum total length of process prior to use; and
D=Inside diameter of piping.

In embodiments where metasilicate, or other mineral salt, infusion is not included in the process for producing the reducing liquid, the distances L_{S} and L_{P} remain the same as in equations (1) and (3) above. Similarly, in embodiments where gas saturation of the source liquid prior to infusion is not included in the process for producing the reducing liquid, the distances L₁ and L_{P} remain the same as in equations (2) and (3) above.

The distance to laminar flow within the piping for critical element optimal performance is given by the following equation:

$${L}_{laminar} = 0.0575 ReD \qquad ( 4 )$$

where Re is the Reynolds Number given by the formula:

$$R e = \frac{ρ u L}{μ}$$

where ρ=density of the fluid, u=flow speed, L=characteristic linear dimension, and μ=dynamic viscosity of the fluid. In a preferred embodiment, for the computation of the Reynolds number the assumptions were modeled for purified water in transit through a 2 in inner diameter pipe at a flow rate of 60 gpm, and a temperature of 30° C. However, it will be appreciated that the exemplary system and method are not limited to operating under this specific set of values, which are provided to illustrate how the characteristic dimension for the system were arrived at. For example, the water may be provided at a nominal flow rate of 80 gpm and optimal operational conditions may be still be achieved provide the other necessary adjustments are made.

The inventors have found that this set of lengths facilitates a laminar flow regime in the conduit 300, thus reducing the occurrence of turbulence and cavitation in the conduit 300, whilst at the same time allowing for sufficient saturation and infusion of the source liquid with the reducing gas and mineral salt(s). The inventors have found that turbulence and cavitation had a detrimental effect on the quality of the product produced in batch processes. In particular, turbulence and cavitation have been found to destabilize the ORP value of a reducing liquid, cause flocculation and/or stratification of the additives, as well as causing an observed adverse drop and or variation in final pH value of the packaged product. Thus, the use of the arrangement illustrated in FIGS. 1 and 3, or FIGS. 2 and 3, for the described method of producing a reducing liquid, have been found to greatly enhance the quality of the final product in terms of ORP value stability and the consistency of the final pH value of the packaged product over time.

Table 1 provides an illustrative example of a variety of pipe diameters, nominal flow rates and required total length L_{P} of the conduit 300 based on equations (1)-(3).

TABLE 1

| Pipe | | |
|---|---|---|
| Diameter | Nominal flow | Required |
| (in) | rate (GPM) | length (in) |
| 1 | 15 | 30 |
| 1.5 | 30 | 45 |
| 2 | 60 | 60 |
| 3 | 80 | 90 |
| 4 | 120 | 120 |

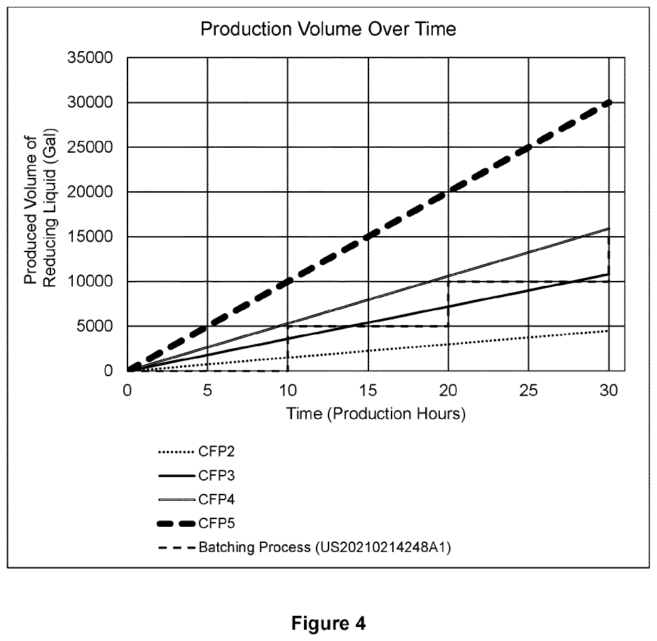

Moreover, by merit of the in-line configuration, the process for producing the reducing liquid can be provided continuously, which greatly augments production rate as can be seen from the chart in FIG. 4 which illustrates how much reducing liquid can be produced using continuous flow process embodiments of the present disclosure compared with the batching process of US20210214248A1.

Although FIG. 4 depicts CFP embodiments with a 2 inch diameter source water feed (CFP2), a 3 inch diameter source water feed (CFP3), and a 4 inch diameter source water feed (CFP4), it will be appreciated by the skilled person that this is not intended to be limiting on the scope of this disclosure and is provided as an illustrative example only. The nominal speed of the production process can be tuned based on specific customer requirements, including auxiliary support equipment. CFP2 and CFP3 data sets would be ideal for a client wishing to produce up to about 5000 gallons continuously in less than a 10 hour timeframe, without a delay (in comparison to the batching process, where continuous flow cannot be achieved). The cumulative delay caused by batching is evident from the stepwise line for batching in FIG. 4. The flat line after each batch indicates times when the tank is recirculating and the time water is unavailable to production filling process equipment. In commercial operations, batching requires equipment such as bottling equipment, waste management systems, packaging solutions, and the like to operate in a stop-start modality which results in a underutilization of resources and sub-optimal running conditions. As can be seen from FIG. 4, the design illustrated in FIGS. 1-3 greatly simplifies the number of components required compared with the known processes for preparing reducing liquids, reducing both costs and time spent on the maintenance of components.

In some embodiments, the conduit 300 may be modular such parts of the piping can be replaced, newly inserted, or removed if not required. Moreover, in some embodiments a plurality of the conduit 300 may be run in parallel and, advantageously, can be connected to the same source of the source liquid, the same source of reducing gas, and/or the same source of mineral salts. Optionally, where a plurality of conduits 300 branch off a single source of the source liquid, the conduits 300 may then also converge again at and share the same static mixing element 150.

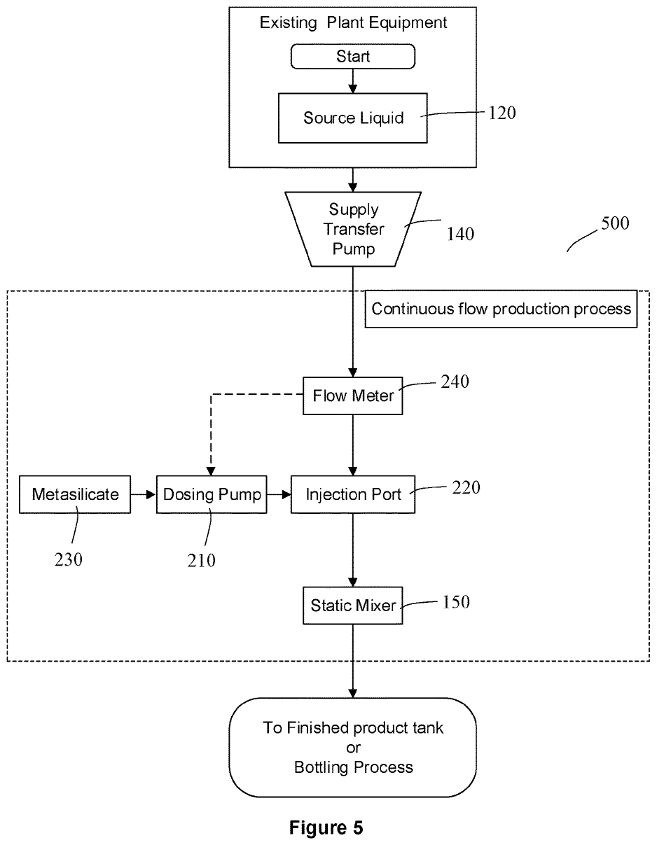

FIG. 5 provides a schematic diagram of a system 500 similar to the system 100 of FIG. 2 for producing a reducing liquid in a continuous flow process, but omitting electrolysis cell 110 and gas introduction element 130. Instead, the system 500 is configured to direct a source liquid 120, for example using supply transfer pump 140, through a volume such as conduit 300 without a step of gas saturation. A metal salt 230, such as a metasilicate, is introduced to the source liquid 120 using a dosing pump 210.

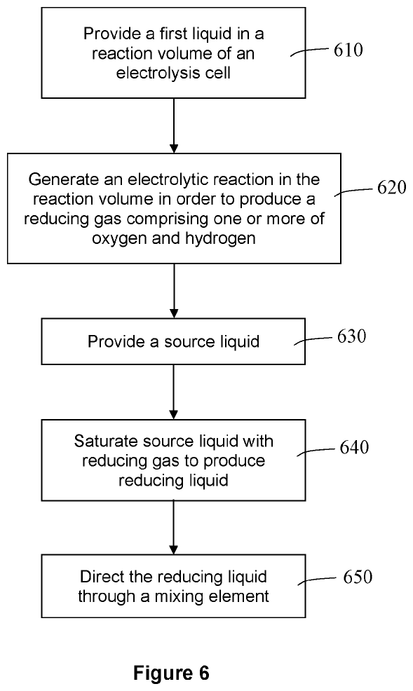

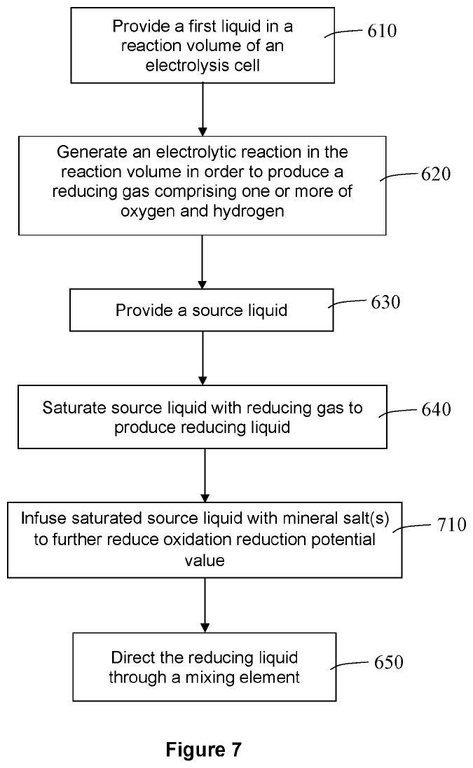

FIGS. 6 and 7 provide flow diagrams illustrating exemplary embodiments of a continuous process for a producing a reducing liquid according to embodiments of the present disclosure. The methods of FIGS. 6 and 7 may be used in conjunction with the systems 100 of FIGS. 1 and 2, respectively, for producing a reducing liquid. In particular, the reducing liquid produced is found to have an ORP value of −100 mV or more negative, and a stable alkaline pH of about +9.5 or higher.

With particular reference to FIG. 6, the method comprises providing a first liquid in a reaction volume of an electrolysis cell; 610. Gas is produced in an electrolytic reaction in the cell; 620. Preferably, the gas produced in the reaction 620 comprises oxygen and hydrogen. The amounts of oxygen and hydrogen will vary dependent on variety of factors including the first liquid selected for the reaction, as well as the inclusion or exclusion of an electrolyte in the reaction volume of the cell. A source liquid is provided 630, preferably to a volume such as but not limited to the conduit 300 of FIG. 3. The source liquid preferably comprises water, and may be sourced from a variety of possible sources, such as but not limited to a municipal waste source, an industrial process, or a natural source. In a further step 640, the source liquid is saturated with the reducing gas produced in the electrolytic reaction of step 620. It will be appreciated that in some embodiments, instead of generating an electrolytic reaction to produce a reducing gas, a pre-prepared source of gas may be used for the step 640 of saturating the source liquid. The result of saturating the source liquid with the reducing gas is a reducing liquid which has been found by the inventors to possess a final ORP of about −100 mV to about −500 mV. Different embodiments of the invention can produce ORP ranges from about 0 mV to −100 mv, about −100 mV to about −300 mV, about −250 mV to about −500 mV, and about −100 mv to about −800 mV depending on configuration based on product and customer needs.

The reducing liquid is then directed through a static mixing element; 650. After the step of mixing 650, the reducing liquid can be bottled or otherwise packaged or stored for subsequent use. In addition or alternatively, after mixing the reducing liquid may be directed to another industrial or other process.

FIG. 7 provides a method of producing a reducing liquid substantially similar to the method of FIG. 6, but further comprising a step 710 of infusing the saturated source liquid from step 640 with mineral salt(s) to further reduce the ORP value of the reducing liquid. The mineral salt may comprise a metasilicate, such as but not limited to Trimeric Sodium Silicate and Sodium Silicate Pentahydrate. Subsequent to mineral salt infusion 710, the reducing liquid is directed through the mixing element 650. As will be appreciated from FIG. 4, in some embodiments the method of FIG. 7 may omit the steps 620, 640 of generating a gas by an electrolytic reaction and saturating the source liquid with the resultant gas of that reaction. In other embodiments the step 620 of generating a gas by an electrolytic reaction may be omitted, and a pre-prepared source of reducing gas may be provided for the step 640 of saturating the source liquid.

In some embodiments, after the step of mixing the reducing liquid in static mixer 150, the pressure of the reducing liquid may be increased where the solution is intended to be bottled at a higher pressure.

In other embodiments, after the step of mixing the reducing liquid in static mixer 150, the pressure of the reducing liquid may be decreased. Decreasing the pressure of the reducing liquid may facilitate removal of dissolved gas from the solution after electron transfer has occurred, for example when preparing medical water.

The pressure of the reducing liquid may be altered using any of the means known to the skilled person, such as but not limited to various valves, pressure regulators, and the like.

The stability of the reducing liquid produced according to embodiments of the present disclosure, such as those of FIGS. 6 and 7, has been tested for 24 months shelf life stability. It has been shown that the product does not exhibit degradation over this time period. Under ambient temperature of 25° C. and 60% Relative humidity, the sample's pH remained stable above 9.5. Total coliforms were found to be at <1 CFU/ml at the end of the 24 month period. Moreover, the water was found to be clear with no odor or flavor detected at the end of the 24 month period. It will be appreciated by the skilled person that these results indicate reducing liquids produced according to the present invention can be deemed “ready-to-drink” and suitable for consumption.

The invention is not limited to the embodiment(s) described herein but can be amended or modified without departing from the scope of the present invention.

It will be understood that, while exemplary features of a system for preparing a reducing liquid in a continuous flow process and elements for use in the preparation thereof have been described, such an arrangement is not to be construed as limiting the invention to such features. Aspects of the exemplary methods for preparing a reducing liquid in a continuous process may be implemented in software, firmware, hardware, or a combination thereof. In one mode, aspects of the methods are implemented in software, as an executable program, and is executed by one or more special or general purpose digital computer(s), such as a personal computer (PC; IBM®-compatible, Apple®-compatible, or otherwise), personal digital assistant, workstation, minicomputer, or mainframe computer. One or more steps of the methods may be implemented by a server or computer in which the software modules reside or partially reside.

1-40. (canceled)

41. A method for preparing a reducing liquid in a continuous process, comprising:
providing a first liquid in a reaction volume of an electrolysis cell;
generating an electrolytic reaction in a reaction volume in order to produce a reducing gas comprising one or more of oxygen and hydrogen;
providing a source liquid in a second volume;
introducing the reducing gas to the source liquid, thereby producing the reducing liquid; and
directing the reducing liquid through a mixing element.

42. The method of claim 41, further comprising adding a metasilicate to the reducing liquid, to produce a liquid having a pH of 9.5 or greater and a ORP of −100 mv or more negative.

43. The method of claim 42, wherein the metasilicate is added to the reducing liquid in an amount in a range of from about 0.5 cc per gallon to about 5 cc per gallon.

44. The method of claim 43, comprising adding the metasilicate to the gas saturated source liquid using a dosing pump or a Venturi.

45. The method of claim 41, comprising introducing the reducing gas in a Venturi.

46. The method of claim 41, wherein the mixing element comprises a static mixing element.

47. The method of claim 41, further comprising the step of providing the source liquid using one or more pumps, a siphon, gravity, or an air pressure differential.

48. The method of claim 41, wherein the source liquid comprises reverse osmosis filtered water, and the source liquid is disinfected using one or more of ozone, ultraviolet light, and a steam distillation process.

49. The method of claim 41, wherein the source liquid comprises wastewater, effluent, or water from an industrial process.

50. The method of claim 41, wherein the electrolysis cell comprises an alkaline water electrolysis cell, and the method further comprises:
providing an electrolyte in the form of a liquid or a solid to the electrolysis cell, and adding water to the electrolyte in order to produce a water-based alkaline electrolyte mixture for the electrolytic reaction.

51. The method of claim 50, wherein the electrolyte provided to the electrolysis cell comprises potassium hydroxide, and/or sodium hydroxide.

52. The method of claim 51, wherein the electrolyte is provided at a density in the range of about 26% and about 30% by weight in solution.

53. The method of claim 42, wherein the second volume comprises a conduit characterised by the following dimensions:
$$L S = 10 ( D ) , and LP = 30 ( D ) ;$$
wherein D is the inside diameter of the conduit, LS is the minimum length of gas
saturation, and LP is the minimum total length of the conduit measured from the gas introduction element to the outflow of the conduit.

54. The method of claim 53, wherein the conduit is further characterized by the following dimensions:
$$L I = 4 ( D ) ,$$
wherein LI is the minimum length of mineral salt infusion prior to mixing.

55. The method of claim 41, further comprising the step of reducing or increasing the pressure of the reducing liquid after directing the reducing liquid through the mixing element.

56. A system for preparing a reducing liquid in a continuous process, comprising:
an electrolysis cell configured to generate an electrolytic reaction in order to produce a reducing gas; and
a conduit configured for receiving a source liquid from a source, the conduit further comprising:
a gas introduction element for introducing the reducing gas to a first liquid in order to produce the reducing liquid; and
a mixing element for receiving the reducing liquid.

57. The system of claim 56, the conduit further comprising a dosing pump for infusing a mineral salt into the reducing liquid, wherein the mineral salt comprises a metasilicate.

58. The system of claim 57, further comprising a flow meter communicatively coupled to the dosing pump.

59. The system of claim 41, wherein dimensions of the conduit are characterised by:
$$L S = 10 ( D ) , and LP = 30 ( D ) ;$$
wherein D is the inside diameter of the conduit, LS is the minimum length of gas saturation, LI is the minimum length of metasilicate infusion prior to mixing, LP is the minimum total length of the conduit measured from the gas introduction element to the outflow of the conduit.

60. The system of claim 59, wherein the conduit is further characterized by the following dimensions:
$$L I = 4 ( D ) ,$$
wherein LI is the minimum length of mineral salt infusion prior to mixing.

61. The system of claim 60, wherein the mixing element is a static mixing element.

62. The system of claim 61, wherein the mixing element comprises one or more of helical portions, square portions, rectangular portions, circular portions, and/or grid(s).

63. The system of claim 56, wherein the electrolysis cell comprises an alkaline water electrolysis cell or a Proton Exchange Membrane (PEM) type generator.

64. The system of claim 63, wherein the electrolyte provided to the electrolysis cell comprises water, potassium hydroxide, and/or sodium hydroxide.

65. The system of claim 56, wherein the electrolyte has a density in the range of about 26% and about 30% by weight in solution.

66. The system of claim 56, wherein the electrolysis cell is configured to generate a voltage in the range of about 2V and about 220V.

67. The system of claim 56, being configured to maintain the reducing gas at a pressure in the range of about 5 psi to about 10 psi in the gas introduction element.

68. A product produced by the method of claim 41 selected from the list comprising: a carbonated beverage, a fruit juice product, ready-to-drink water, a tea product, a coffee product or a medicament.
